(19) United States
(12) Patent Application Publication
(10) Pub. No.: US 2012/0030228 A1
(43) Pub. Date: Feb. 2, 2012

(54) METHOD AND SYSTEM FOR NEED FULFILLMENT

(75) Inventors: Enaganti Bhaskar Naidu, Sunnyvale, CA (US); Bharath Kumar Yadla, Sunnyvale, CA (US); Krishna Panyam, Bangalore (IN); Khanderao Dattatray Kand, San Jose, CA (US)

(73) Assignee: GLOMANTRA INC., Sunnyvale, CA (US)

(21) Appl. No.: 13/020,020

(22) Filed: Feb. 3, 2011

Related U.S. Application Data
(60) Provisional application No. 61/300,838, filed on Feb. 3, 2010.

(51) Int. Cl. G06F 17/30

(52) U.S. Cl. 707/767; 707/E17.137

(57) ABSTRACT

A method, a system and a computer program product for providing solutions for fulfilling a need of a user are provided. A query is received for capturing the need of the user. The need is processed to generate a set of actionable recommendations. Further one or more actions are identified by analyzing the recommendations. Furthermore, the actionable recommendations are provided to the user. The system includes a processing module to process the need to generate set of actionable recommendations. The actionable recommendations may be based on the user's preferences. The system further includes an Enriching module to provide richer information about the recommendation and to provide one or more actions for the fulfillment of needs. The system further includes a crystallization module for iterative processing of the need for more relevant recommendations. Further, the user is enabled to get opinion, about the recommendations, from other users.

### REFERENCE TO PRIORITY APPLICATION

This application claims priority from U.S. Provisional Application Ser. No. 61/300,838 filed Feb. 3, 2010, entitled “eSolution for Need Fulfillment”, which is incorporated herein by reference in its entirety.

### FIELD

The present invention relates to the field of providing personal assistance to a user, and more particularly, to fulfilling needs of the user by providing personal assistance to the user.

### BACKGROUND

Internet is been widely utilized by users all over the world in order to search information related to various fields. Users often perform web searches to acquire information present in the World Wide Web. However, web searches provide a large list of information to the users. Hence the users are burdened with selecting relevant information from the large list of information. Further, the users, generally, contact friends or experts for the purpose of decision making to select relevant information from the large list of information.

Conventionally, the users utilize various web search engines to acquire information present in the World Wide Web. Examples of search engines include, but are not limited to, Google.com, Yahoo.com, Ask.com, Shopzilla.com, altavista.com and Webcrawler.com. Further, the users can perform various activities using the World Wide Web. Examples of various activities include, but are not limited to, business transactions, banking, entertainment and trade. The search engine utilizes various search methods to provide a generic result corresponding to a search query provided by a user. Conventionally, such search methods provide the result based on keywords present in the query. The result, provided by the search engine, typically includes stale and irrelevant information along with relevant information, with respect to the user's query. The user is burdened with tasks of searching the relevant information from the result provided by the search engine. Further, such tasks of manual searching of the relevant information consumes a significant time of the user.

Further, if the result does not or negligibly include relevant information, the user is required to restart the search, by providing different search query, to get relevant result. Additionally, the search methods restrains from understanding intent and context of the search query provided by the user. Due to this, the user needs to spend time, iteratively, in thinking and applying the relevant search query to get the relevant result (relevant information) corresponding to the user's query.

Furthermore, the user communicates with friends and experts to get recommendations, for further decision making in acquiring relevant information corresponding to a concept of the search query. Such communication, with friends and experts, is performed, manually, by using various communication mediums. Examples of various communication mediums include, but are not limited to, emails, Short Message Service (SMS), social networking sites and telephones. However, these communication mediums are not integrated with the conventional search methods and hence results in incurring additional time for searching relevant information. Further due to this, the user may again need to utilize the search engine for applying a new search query, manually, corresponding to the received recommendations. Thus, such processes of utilizing search methods for getting relevant information are time and effort consuming.

In the light of the foregoing discussion, there is a need for an efficient method and system for providing set of solutions to fulfill needs of the user and to overcome the abovementioned shortcoming in the field of the present invention.

### SUMMARY

To address shortcomings of the prior art, the present invention provides a method, a system and a computer program product to fulfill a need of a user.

An example of a method for providing one or more solutions to fulfill a need of a user includes capturing the need of the user. The need is captured by receiving a query from the user. The method also includes processing the need to generate a set of actionable recommendations. The need being processed by determining a type of the need. The method further includes enriching the set of actionable recommendations by identifying one or more actions corresponding to the set of actionable recommendations. The one or more actions being identified by analyzing the set of actionable recommendations. Further, the method includes providing the enriched set of actionable recommendations and one or more features corresponding to the one or more actions to the user. The one or more features enabling the user to perform at least one of the one or more actions corresponding to the enriched set of actionable recommendations.

An example of a method for providing solutions for fulfilling a need of a user includes receiving a query from a user. The query is received for capturing the need of the user. The method also includes processing the need to generate a set of actionable recommendations. The need is processed by determining a type of the need. Further, the method includes providing the set of actionable recommendations to the user. Also, the method includes enabling the user to get opinion corresponding to the set of recommendations. The user being enabled to get opinion from one or more other users for example, but not restricted to, friends, experts or from public. Furthermore, the method enables the user to perform one or more actions corresponding to at least one of the set of actionable recommendations, thereby providing the solutions for fulfilling need of the user.

An example of a system for providing one or more solutions to fulfill a need of a user includes a need capturing module configured to capture the need of the user. The need capturing module captures the need by receiving a query from the user. Further, in an embodiment, the need may also be captured through the user's context such as need situational context, and location context. The system also includes a processing module configured to process the need to generate a set of actionable recommendations. The need being processed by determining a type of the need. The system further includes an enriching module to enrich the set of actionable recommendations by identifying one or more actions corresponding to the set of actionable recommendations. The one or more actions being identified by analyzing the set of actionable recommendations. Further, the system includes an output module for providing the set of actionable recommendations and one or more features corresponding to the one or more actions for enabling the user to perform at least one of the one or more actions corresponding to the set of actionable recommendations. Moreover, the processing module may enable the user to receive opinions from one or more users of one or more social networks through various communication mediums such as social networking sites, public sites and the like. Further, the system may include a crystallization module employed to refine the need of the user.

An example of a computer program product comprising a non-transitory computer usable medium having a computer readable program code embodied therein for providing one or more solutions to fulfill a need of a user. The computer program code, when executed, performs a method that includes capturing the need of the user. The need captured by receiving a query from the user. The method also includes processing the need to generate a set of actionable recommendations. The need being processed by determining a type of the need. The method further includes enriching the set of actionable recommendations by identifying one or more actions corresponding to the set of actionable recommendations. Each the one or more actions being identified by analyzing the set of actionable recommendations. Further, the method includes providing the enriched set of actionable recommendations and one or more features corresponding to the one or more actions to the user. The one or more features enabling the user to perform at least one of the one or more actions corresponding to the enriched set of actionable recommendations. One of the actions would be ‘Get opinion’ from other users, friends, experts or public.

Here, the set of actionable recommendations may have limited number of recommendations such as ‘1’ to ‘9’. Additional details such as situational context, users' context and location may also be utilized for capturing the need. Further, the actionable recommendations may be relevant and personalized to the need of the user. Further, the user may be enabled to crystallize the need and to provide feedback to iterate the need processing for refined and relevant recommendations. Also, the method enables the user to share the feedback (experience) with other users, friends or public.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a block diagram of an environment in accordance with which various embodiments can be implemented;

FIG. 2 illustrates a block diagram of a system for providing a set of solutions to fulfill a need of a user, in accordance with one embodiment of the present invention;

FIG. 3 illustrates a block diagram of a system for providing a set of solutions to fulfill a need of a user, in accordance with another embodiment of the present invention;

FIG. 4 is a flow chart illustrating a method for providing a set of solutions to fulfill a need of a user, in accordance with one embodiment of the present invention;

FIG. 5 is a flowchart illustrating a method for providing a set of recommendations to a user, in accordance with one embodiment of the present invention;

FIG. 6 represents an exemplary illustration for need fulfillment in accordance with one embodiment of the present invention;

FIG. 7 is an exemplary illustration for set of recommendations and corresponding actions associated with the need;

FIG. 8 is a flowchart illustrating a method for getting opinion for set of recommendations in accordance with one embodiment of the present invention;

FIG. 9 is a block diagram to illustrate Share and Shout-Out actions in accordance with one embodiment of the present invention; and

FIG. 10 is an exemplary illustration of a need associated with relevant actions for fulfilling the need, in accordance with one embodiment of the present invention.

In the following drawings like reference numbers are used to refer to like elements. Although the following figures depict various examples of the invention, the invention is not limited to the examples depicted in the figures.

### DETAILED DESCRIPTION

A method, a system, and a computer program product for providing one or more solutions to fulfill a need of a user are disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

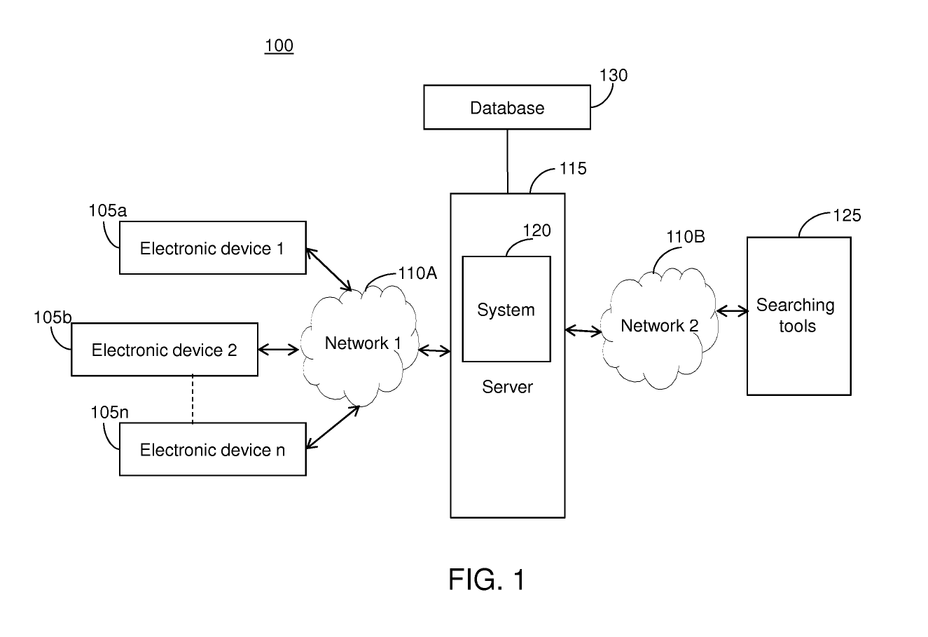

FIG. 1 is a block diagram of an environment 100 in accordance with various embodiments of the present invention. The environment 100 includes one or more electronic devices such as an electronic device 1 105a, an electronic device 2 105b, . . . to an electronic device n 105n, network 110A and a network 110B, a server 115, a system 120, searching tools 125, and a database 130.

A user can express a need using an electronic device such as an electronic device, say 105a. Examples of the electronic devices include, but are not limited to, desktop, laptop, hand held computers, mobile phone, personal digital assistant (PDA), smart phones, digital television (DTV), internet protocol television (IPTV), and play stations. The need can be categorized into various classifications. Examples of classifications include, but are not limited to, a personal need, an informational need and a social need. The need expressed by the user may be provided to the system 120 through the network 110A. The system 120 may process the need. Upon processing, the system 120 may provide one or more recommendations. In one embodiment, the one or more recommendations represent one or more actionable tasks that can be accomplished to fulfill the need of the user.

The system 120 can be uploaded to the server 115. Furthermore the system 120 can also be installed as an application on, for example, but not limited to, social networking sites, private sites and public sites. Moreover, the system 120 can also be a standalone module that can be used to fulfill the needs of the user. The need can be expressed by the user using a Graphical User Interface (GUI) of the system 120.

In one example, the user can express the personal need. The personal need can be transmitted to the system 120 through the network 110A. Examples of network include, but are not limited to, internet, Ethernet, local area network (LAN), wireless, wide area network (WAN), metropolitan area network (MAN), and small area network. The system 120 may process the personal need of the user. Upon processing, the system 120 transmits the one or more recommendations associated with the personal need to the user. In one example, the one or more recommendations can be a message responsive to the personal need.

Further, in another example, the user can also express the informational need. The need expressed by the user can be transmitted to the system through the network 110A. The system 120 may process the need to search one or more recommendations responsive to the need.

The system 120 can communicate with the database 130 to acquire one or more recommendations associated with the need of the user. The database 130 can be a standalone unit connected to the server directly. The database 130 may include an organized collection of data. The organized collection of data includes one or more recommendations associated with the need. A database management system may be utilized to manage the data stored in the database 130.

Further, the system 120 can communicate with searching tools 125. Searching tools include, but not limited to, search engines such as Google.com, Yahoo.com, Ask.com, Shopzilla.com, altavista.com and Webcrawler.com. Further, searching tools also include specialized sites such as Amazon, kayak, rottentomotoe and the like. Furthermore search engines include catalogs like Yelp, yahoo local, answers.com and the like. Moreover search tools also include domain specific sites such as movies.com, travels.com and the like. The system 120 can communicate with searching tools 125 through the network 110B to obtain the one or more recommendations associated with the need. The system 120 may search the one or more recommendations responsive to the need from the searching tools 125. The one or more recommendations obtained by the system 120 are provided to the user of the electronic devices through the network 110A.

Furthermore, the searching tools 125 can have access to various websites. Examples of various websites include, but are not limited to, social networking sites, for example, Orkut, Facebook and twitter, public networking, domain sites and private sites. Various websites may be employed to obtain the one or more recommendations associated with the need. Various social networking sites and public networking sites allow one or more users to express their notion on a particular recommendation associated with the need.

Moreover, the system 120 can have access to various domain specific sites. Examples of domain specific sites include, but are not limited to, movies.com and travels.com. Domain specific sites are employed to identify a domain corresponding to the need. Upon identification, the system 120 may perform search to obtain recommendations associated with the identified domain.

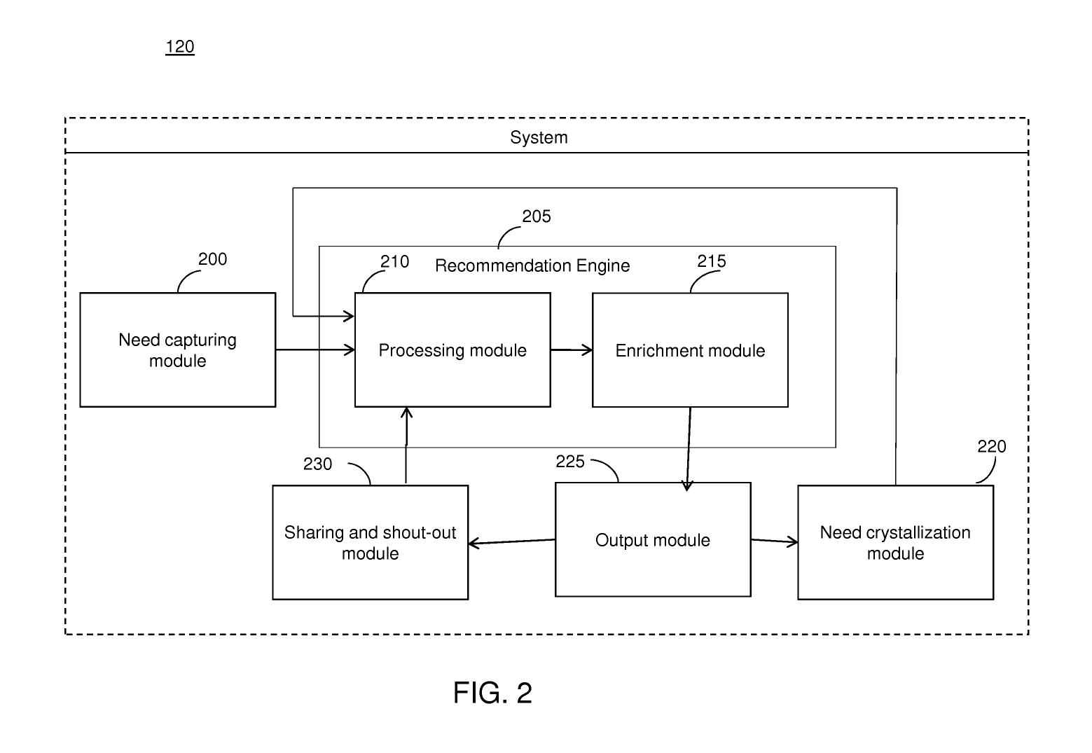

FIG. 2 illustrates a block diagram of a system 120 for providing a set of solutions to fulfill a need of a user, in accordance with one embodiment of the present invention. The system 120 may include, but is not limited to, a need capturing module 200, a Need Recommendation engine 205 having a processing module 210 and an enrichment module 215, a need crystallization module 220, an output module 225, and a share and shout-out module 230. In an embodiment, the processing module 21

The user may provide a query to the system 120. The query may be received by the need capture module 200 to capture the need, of the user. The query may be represented in various forms such as textual format, a video format, an audio format, an image and the like. The need capturing module 200 may capture the need by analyzing the query. A need can be expressed as a text, voice, or an image. The need entered as a voice is converted into a text string using, in one example, a voice to text conversion module. The need capturing model also provides Context of the Need. The context can be personal context, situational context, location, and the like. Further, the need capturing module utilizes information present in the rich context for capturing the need. Rich context includes users profile information such as family members, birth dates, current location of the user, current events, current situation of the user and the like. The captured need may be provided further to the processing module 210 to perform further processing of the need.

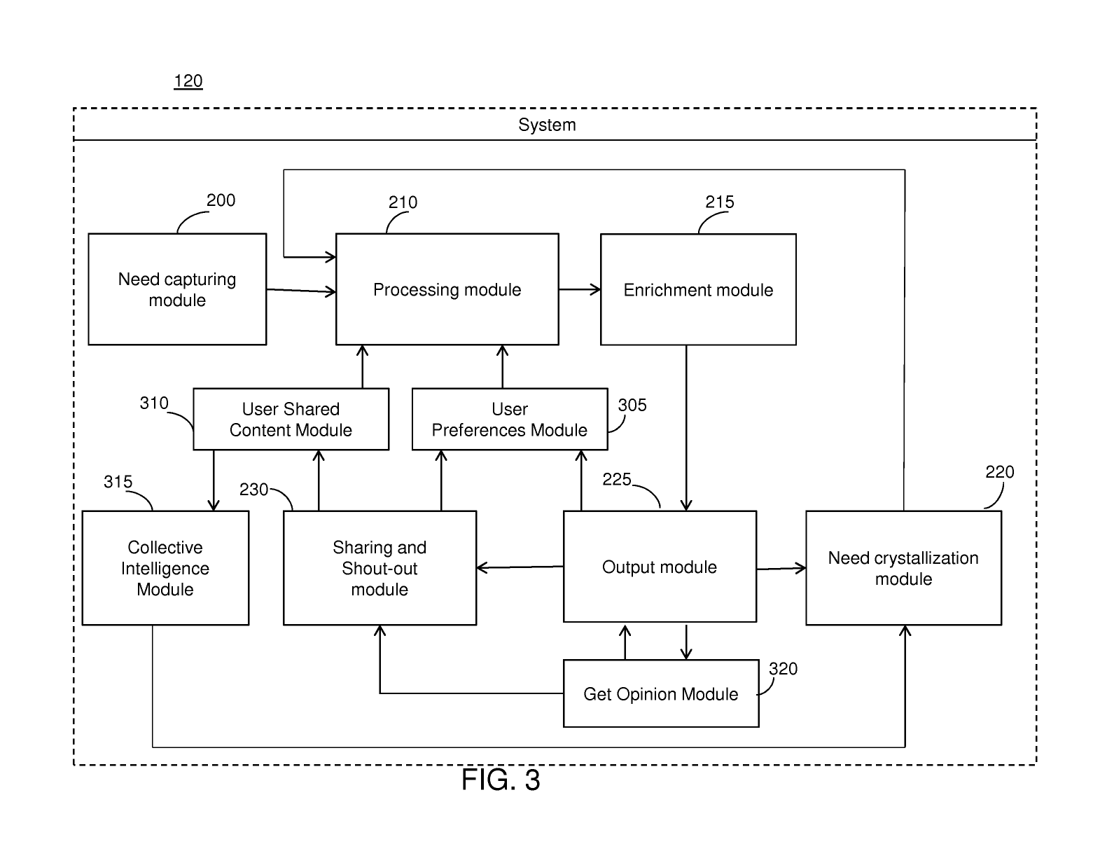

The Need Recommendation Engine 205 provides one or more relevant actionable recommendations for the need. The Need Recommendation Engine 205 may include the Need Processing Module 210 and the Enrichment Module 215. The processing module 210 may process the need (captured by the need capturing module 200) of the user. The need may be processed to understand the intention of the need. In one example, if a need is associated with a product such as searching for an LCD TV, then an intention associated with the product may include to buy the LCD TV or to get reviews about different models of the LCD TV. In an embodiment, the processing module 210 may process the need by determining a type of the need. The need may be of various types such as personal need, social need, informational need and the like. The various types of need are explained further in conjunction with FIG. 3.

Further, the need is processed to generate set of actionable recommendations in response to the need. The set of actionable recommendations may include recommendations that may enable the user to perform corresponding set of actions to fulfill the need. The processing module 210 may process the need by utilizing various phases. Examples of various phases include, but are not limited to, a need analysis phase, searching phase, aggregation phase, filtering phase and generating phase for generating set of recommendations associated with the need. The need analysis phase, of the processing module 210, may analyze the need to understand the intent of the user.

Further, the need may be analyzed by analyzing a need statement such as statement provided in a query text. The need statement may include text describing various parts of speech, for example, verb, noun, pronoun, adjective, adverb, preposition, conjunction and interjection. Further, in the need analysis phase, the processing module 210 may segregate the text describing the various parts of speech, to identify the intention of the need. In one embodiment, the processing module 210 may utilize a Natural Language Processing (NLP) algorithm to perform such segregation of the text. The NLP algorithm may identify natural human language and convert it into a format that can be interpreted for computer program manipulation purposes.

Also, the processing module 210 may identify entities expressed in the need. Entities may be identified by processing the statement of the need (query). For example, an entity may be regarded as, in one example, a renowned movie artist. Additional examples of entities may include, but are not limited to, places, things to do, person/people, activity/activities, products/artifacts to buy, and the like. Further, in another example, the entity may be regarded as a location mentioned in the statement of the need. Entities can be identified using various algorithms. In one example, a Right Most Matching algorithm can be used to identify the entity. Other examples of algorithms may include, but are not restricted to, date extraction algorithm, location extraction algorithm, etc.

Furthermore, the processing module 210 may determine one or more domains associated with the need. A domain categorization technique may be utilized by the processing module 210 to determine the domain associated with the need. The domain categorization technique may include various phases. Examples of such various phases include, but are not limited to, an entity extraction phase and an entity recognition phase. The entity extraction phase is performed to extract an entity associated with the need. The entity recognition phase is employed to perform matching of the entity associated with the need with a plurality of entities stored in a reference database system or in an external entity databases or entity recognition services. Examples of the reference database system can include, but are not limited to, a Wordnet, and a Freebase. Upon matching the entity with one of the plurality of entities stored in a reference database system, the domain associated with the entity may be determined.

In another embodiment one or more search engines may be searched for the key phrases identified by the entity extraction algorithm or the original text string is submitted. The search engines returns a set of results along with their URLs and matched phrases and their counts. The phrases with maximum score that is maximum matches can be identified as entities. The URLs can be searched against a set of vast bug popular URLs that are maintained by the solution along with their domains identified programmatically based on the Meta-Information specified by the site provided or manually entered by the system operator. The search results URLs are matched with the list of URLs and count for matched domain is derived. Similarly, the entity extraction module may identify verbs. The system may maintain a map of verbs and their possible domains and intentions. Based on the verb matching, the domain categorization may further be refined. Both the URL mapping as well as verb mapping is further augmented by other entities extracted from the need statement. The other entities are matched for entity database for places, products, movies, people etc. Their matching to different domains gives the domain counts for the need. The domain and intent derived from these various matching gives possible domains and their weightage.

In one example, if the entity is identified as Jennifer Lopez, then the various domains associated with Jennifer Lopez can be considered. The various domains can include a movie domain as she being an actress, as well as a music domain as she also being a singer. The weight associated with each of the domains may be calculated by the processing module 210. Further, top few, mostly one or two, domains with highest weights may be preferred by the processing module 210. Further, the processing module 210 may store a list of domains in a database. The list of domains may be determined based on the frequencies of domains. The list of domains aids the user to determine the domain associated with the need without much time consumption.

It may be appreciated by any person skilled in the art that the result of various phases may be stored, in a database (not shown), for processing the need of the user in future.

Upon determining the domain(s) associated with the need, the processing module 210 may perform search to obtain set of recommendations from sources relevant to the domain(s). The set of recommendations may be actionable corresponding to the need. The processing module 210 may perform searching of the set of recommendations from various sources based on the type of the need (as explained earlier and further in conjunction with FIG. 3). Examples of various sources include, but are not limited to, social networking web sites, search engines and specialized web sites for domain specific information such as yelp, Amazon, Lst.fm, Saber and the like.

Further, in an embodiment, the processing module 210 may include a value addition module (not shown) to identify set of available schemes and savers corresponding to the set of recommendations. The schemes or savers may include a promotional offers corresponding to the set of recommendations. Such schemes and savers may add value to the recommendations. In one example, get coupon is a value addition based on user's request. The value addition is associated with the recommendations provided to the user.

Further, information corresponding to any scheme/savers may be provided to the user along with the set of recommendations. For example, if on a purchase of a product, a lucky draw coupon is available, as a promotional offer, then the user may be provided with an option, along with the recommendation for the product, to receive (or utilize) the lucky draw coupon on the purchase of the product. It may be appreciated by any person skilled in the art that such savers/schemes may directly be utilized by the user to get benefit on the selection of corresponding recommendation.

Upon obtaining the set of recommendations, the enrichment module 215 may analyze each of the set of recommendations. The set of recommendations may be analyzed to determine set of actions associated with each of the set of recommendations. The enrichment module 215 may utilize various algorithms to determine the set of actions associated with each of the set of recommendations. In one embodiment, an algorithm may be based on a map of domain, intention associated with the need and a set of possible actions that are captured in a map stored in the persistent store of the system and referred in identifying the actions. For example, actions corresponding to movie recommendation may include find nearby theaters running the movie, book a ticket, get reviews, get opinion, get discount coupon on the movie, and the like. Additionally, various other actions may include, but are not limited to, sharing, shouting-out, getting opinion, and thrashing out un-liked recommendation.

Further, the enrichment module 215 may enrich the set of recommendations with the value additions. The value additions may provide additional information corresponding to the set of recommendations. In one example, value additions may include, but are not limited to, coupons, offers, discounts and the like associated with the recommendations. The system may maintain a possible map of type of recommendation, corresponding domain and intent with specific set of corresponding information. The system may retrieve the information from local or external sources. Upon determining the action, each of the set of recommendations, may be provided to the output module 225. The output module 225 may provide the set of recommendations and the corresponding actions to the user.

In an embodiment, if the recommendations provided to the user are not sufficient to fulfill the need of the user, the user may crystallize the need to find the relevant recommendations corresponding to the need of the user. The need crystallization module 220 may be employed to refine the need of the user. The need crystallization module 220 may perform various actions to refine the need of the user. The need may be refined to identify the need of the user accurately. Examples of various actions include, but are not limited to, a need refinement and an intent analysis.

During the need refinement, the crystallization module 220 may provide multiple hints to the user. Such hints may be regarded as keywords employed to improve the need. The user may be enabled to select one or more hints to indicate the intent of the need. Further, the intent analysis may also provide various options describing the intent of the user. Examples of various options include, but are not limited to, a ‘find similar option’, ‘you may be interested in’, a ‘trash-it’ option and a ‘pin-in’ option. The ‘find similar option’ indicates an interest of the user in a particular recommendation. The ‘you may be interested in’ is a need crystallization option at a Need level.

In the Need Crystallization, an example, if ‘Find-Similar-Option’ is selected for a recommendation, concepts (in form of keywords or phrases) are presented to the user. The concepts (or hints) may be provided by the processing module 210 and include keywords that are relevant to the recommendation. For example, for a recommendation of restaurant nearby, concepts may be such as type of restaurants like Italian, Indian and the like, type of associated services such as beer bar, dance bar, and the like, or pet friendly etc. Similarly, for concepts, related to a recommendation for a LCD TV, may include size of the TV, brands like Sony, LG etc., pixels, price range, stores etc. The user is enabled to select the concepts. The ‘Find-Similar-Option’ is selected when user likes the recommendation or may feel that the recommendation is closer to the need of the user and when the user wants to get more recommendations similar to the one that was selected. The ‘trash-it’ option selected by the user indicates the lack of interest over the particular recommendation. The user can save the particular recommendation for future use utilizing the ‘pin-in’ option. The user may also provide/select hints that can alter the need of the user.

The need crystallization module 220 may provide the hints and options to the user. The user may select a hint to represent the need so as to get more relevant recommendation. The need crystallization module 220 may further provide a crystallized need to the processing module 210 to process the crystallized need (as explained earlier) and to search one or more relevant (improved) actionable recommendations to fulfill the need of the user. Further, the enrichment module 215 may determine set of actions corresponding to the relevant recommendations.

The set of recommendations and features to perform the corresponding actions associated with the need may be provided to the user using the output module 225. The output module 225 may display the one or more recommendations and the corresponding one or more actions to the user. The user can select a recommendation that is relevant to the need from the one or more recommendations displayed by the output module. Further, the user may perform one or more actions by utilizing the features.

Further, the user may be enabled to share the set recommendations associated with the need by utilizing the ‘Share and Shout-Out’ module 230 of the system 120. The one or more recommendations may be shared among various groups of people, for example, friends, colleagues and the like. Such sharing can be performed over various communication mediums. Examples of various communication mediums include, but are not limited to, emails, short messages and social networking sites. Furthermore the ‘Share and Shout-Out’ module also allows the user to express various impressions or to provide feedback for the one or more recommendations associated with the need.

Further, the user can utilize the share and shout-out module 230 to share the notion of the user associated with the recommendation. In one example the interest or disinterest of the user over the set of recommendations can be shared by the user, using the share and shout-out module. In one embodiment share and shout-out module can also be referred to as a feedback module.

It may be appreciated by any person skilled in the art that the user may be enabled to save the need along with corresponding recommendations. Further, the saved need along with corresponding recommendations may be utilized for future references.

FIG. 3 illustrates a block diagram of a system for providing a set of solutions to fulfill a need of a user, in accordance with another embodiment of the present invention. The block diagram includes a need capturing module 200, a processing module 210, an enrichment module 215, a need crystallization module 220 (hereinafter referred to as crystallization module 220), an output module 225, a Sharing and Shout-out module 230, a user preference module 305, a User Shared content module 310, a collective intelligence module 315, and a get opinion module 320.

The user may provide a query to the system 120. The query may be received by the need capture module 200 to capture the need, of the user. The query may be represented in various forms such as textual format, a video format, an audio format, an image and the like. The need capturing module 200 may capture the need by analyzing the query. A need can be expressed as a text, voice, or an image. The need entered as a voice is converted into a text string using, in one example, a voice to text conversion module. The need capturing model also provides Context of the Need. The context can be personal context, situational context, location, and the like. Further, the need capturing module utilizes information present in the rich context for capturing the need. Rich context includes users profile information such as family members, birth dates, current location of the user, current events, current situation of the user and the like. The captured need may be provided further to the processing module 210 to perform further processing of the need.

The user preferences module 305 (hereinafter may alternatively be referred to as personalization module 305), may be used to capture information present in a rich context. The rich context may include information corresponding to the user's profile such as family members, current location of the user, Birth date of the user, current situation of the user, current event and the like. The user's profile may include information or preferences explicitly indicated by the user to the system. For example, user may indicate type of movies or restaurants the user likes, etc. Further, the user preferences module 305 may be used to determine user preferences based on history of the user's previous interaction with the system, such as the system 120. For example, the user may have submitted earlier need for finding good Italian restaurants and Indian restaurants more than other types of restaurants. The User Preference module 305 may maintain a count for each type of restaurants the user asked for, or liked or booked table for. If the count for the user's linking or booking of types of restaurants is above some threshold value, then such types of restaurants may be considered as the user's preferences.

Furthermore, the User Preferences module 305 may be used to determine a notion of the user with respect to recommendations, for example, a “like” option selected by the user previously for a recommendation associated with a similar need. The User Preference module 305 may capture such information to understand the need and an intention associated with the need. Such information may be provided to the processing module 210 that may provide the recommendations more relevant to the specific user based on the user's preferences. For example, the user who likes Italian and Indian restaurants may see more recommendations for Indian and Italian restaurants than other restaurants. Also, the User Preferences module 305 may maintain the user's preference for different types of Needs or domains. For example, the User Preference module 305 may maintain the user's choices for Restaurants, movies, airlines, product brands, sports team, music type, music band, artists, and the like.

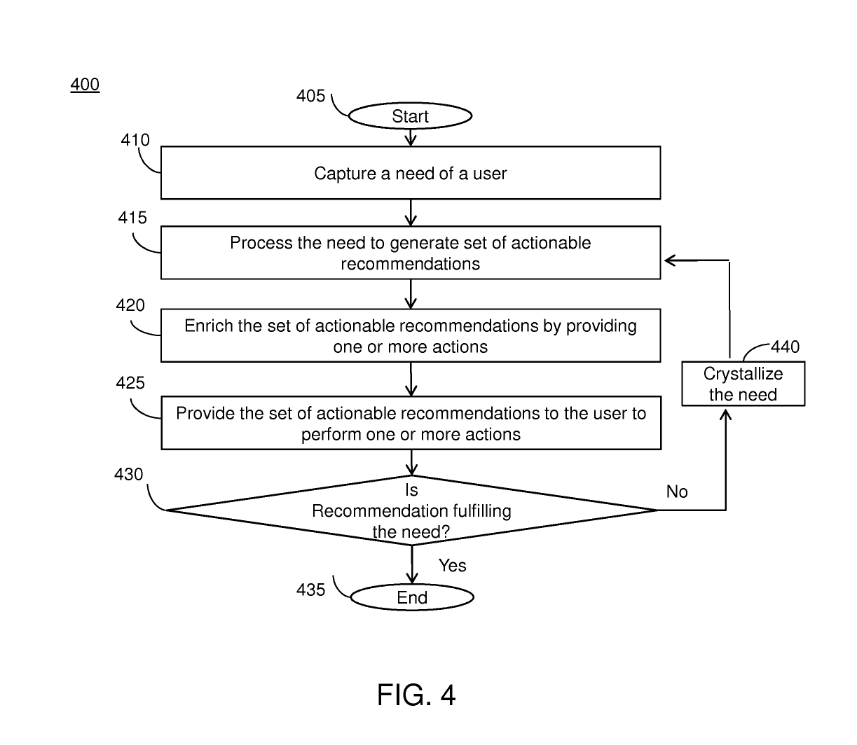

The processing module 210 may process the need (captured by the need capturing module 200) of the user. The need may be processed to understand the intention of the need. Further, the need may be processed based on the information acquired from the personalization module 305. In an embodiment, the processing module 210 may process the need by determining a type of the need. The need may be of various types such as personal need, social need, informational need and the like. The various types of need are explained further in conjunction with FIG. 4.

Further, the need is processed to generate set of actionable recommendations in response to the need. The set of actionable recommendations may include recommendations that may enable the user to perform corresponding set of actions to fulfill the need. The processing module 210 may process the need by utilizing various phases. Examples of various phases include, but are not limited to, a need analysis phase, searching phase, aggregation phase, ranking-filtering phase and generating phase for generating set of recommendations associated with the need. The need analysis phase, of the processing module 210, may analyze the need to understand the intent of the user.

Further, the need may be analyzed by analyzing a need statement such as statement provided in a query text. The need statement may include text describing various parts of speech, for example, verb, noun, pronoun, adjective, adverb, preposition, conjunction and interjection. Further, in the need analysis phase, the processing module 210 may segregate the text describing the various parts of speech, to identify the intention of the need. In one embodiment, the processing module 210 may utilize a Natural Language Processing (NLP) algorithm to perform such segregation of the text. The NLP algorithm may identify natural human language and convert it into a format that can be interpreted for computer program manipulation purposes. The user may not necessarily enter the need statement in natural human language. More users on the internet often prefer to enter keywords instead of full statement. It may be appreciated by any person skilled in the art that the Processing module 210 may parse such statements to identify point of statements like nouns, verbs etc.

Also, the processing module 210 may identify an entity associated with the need. An entity may be identified from the statement of the need (query). For example, the entity may be regarded as, in one example, a renowned movie artist. Further, in another example, the entity may be regarded as a location mentioned in the statement of the need. Entities can be identified using various algorithms. In one example, a Right Most Matching algorithm can be used to identify the entity.

Furthermore, the processing module 210 may determine a domain associated with the need. A domain categorization technique may be utilized by the processing module 210 to determine the domain associated with the need. The domain categorization technique may include various phases. Examples of such various phases include, but are not limited to, an entity extraction phase and an entity recognition phase. The entity extraction phase is performed to extract an entity associated with the need. The entity recognition phase is employed to perform matching of the entity associated with the need with a plurality of entities stored in a reference database system or in an external entity databases or entity recognition services. Examples of the reference database system can include, but are not limited to, a Wordnet, and a Freebase. Upon matching the entity with one of the plurality of entities stored in a reference database system, the domain associated with the entity may be determined.

Furthermore, the Processing module 210 would search internal and external sources, identified as 125 in FIG. 1, for information related to retrieved entities for example, but not limited to, product, movie, restaurant, etc. The Processing module 210 may search only the sources that are relevant to the identified domains and understood intent. The processing module 210 may maintain a map of domains, their intents and the target sources to retrieve information from.

The Processing Module 210 may receive the results from one or more contacted sources identified earlier as 125 for example, but not limited to, search engines, domains specific sites, online service providers, catalogs, directory services, review sites, social networking sites, etc.

The Processing Module 210 may aggregate the results and rank them according to one or more algorithms. The Processing Module 210 would get the user's preferences, from the User Preferences Module 305, relevant to the identified domain and intent corresponding to the need. The Processing Module 210 may further use the user's preferences in ranking the recommendations such that the user's favored preference would be ranked higher. The Processing Module 210 may further filter out any recommendations that can be considered as noise or false matches. The Processing Module 210 may further eliminate duplicates. Finally, the processing module 210 may select a set of relevant recommendations from all the recommendations.

Upon obtaining the set of recommendations, the enrichment module 215 may analyze each of the set of recommendations. The set of recommendations may be analyzed to determine set of actions associated with each of the set of recommendations. The enrichment module 215 may utilize various algorithms to determine the set of actions associated with each of the set of recommendations. Further, the enrichment module 215 may enrich the set of recommendations with the value additions. The value additions may provide additional information corresponding to the set of recommendations. In one example, value additions may include, but are not limited to, coupons, offers, discounts and the like associated with the recommendations. Further, the enriched set of recommendations may be provided to the output module 225. The output module 225 enables the user to select the set of enriched recommendations for performing actions responsive to the need. The enrichment module 215 may further be understood more clearly when read in conjunction with description of FIG. 2.

In an embodiment, if the recommendations provided to the user are not sufficient to fulfill the need of the user, the user may crystallize the need to find the relevant recommendations corresponding to the need of the user. The need crystallization module 220 may be employed to refine the need of the user. The need crystallization module 220 may perform various actions to refine the need of the user. The need may be refined to identify the need of the user accurately. Further, need crystallization is performed to obtain more relevant actionable recommendations.

During the need refinement, the crystallization module 220 may provide multiple hints to the user. Such hints may be regarded as keywords employed to improve the need. The user may be enabled to select one or more hints to indicate the intent of the need. Further, the intent analysis may also provide various options describing the intent of the user. Examples of various options include, but are not limited to, a ‘find similar option’, a ‘trash-it’ option and a ‘pin-in’ option.

Further, the User Preference Module 305, as explained earlier, captures the users history based on the users interaction with the recommendations such as performing actions as LikeIt, ShoutOut, ThrashIt, Share, Buy or book a ticket etc. These actions on recommendations may indicate the user's preference about the recommendation.

The user may use the Get Opinion Module 320 to get opinion on the set of recommendations presented by the output module 225. The get opinion 320 may be utilized for acquiring opinions from one or more users of one or more social networks such as friends and experts as well as from public. The opinion may be obtained from various communication mediums such as social networking sites, public sites like Yelp, Yahoo reviews for an example and the like. The opinion may provide a notion of the public, friends and experts on a particular recommendation. The received opinions can be useful for the user to choose one or more recommendations out of the set of presented recommendations.

Further, the User Shared Content module 310 may store users' feedback on the set of recommendations such as “like”, “dislike”, “trash-it”, and “pin-in” as explained in conjunction with FIG. 2. The opinions obtained from various communication mediums may be stored in the Users shared Content module 310 for future references. In one embodiment, the User Shared Content module 310 may be associated with a database for storing the users' feedback and the opinions. The users' feedback and opinions may be provided to the processing module 210 to obtain recommendations more relevant to the need of the user. The Processing module 210 may use the User Shared Content Module 310 as one of the sources for retrieving recommendations, reviews or opinions.

Further, collective intelligence module 315 may use the preferences of various users to recommend by presenting other users' preferences for the similar needs or preferences liked recommendations or acted on recommendations. The preferences and choices (received from the Collective Intelligence module 315) made by other similar users, maybe utilized by the crystallization module 220 in order to provide the information to the user for enabling the user to decide or crystallize the need. The collective intelligence module 315 may provide information such as the rich context, user preferences, user's history and hints utilized for crystallizing the need. Further, the collective intelligence module 315 may be regarded as a database for storing information required for crystallizing the need.

FIG. 4 is a flow chart illustrating a method 400 for need fulfillment in accordance with one embodiment of the present invention. The order and number of steps in which the method 400 is described is not intended to be construed as a limitation.

The method starts at step 405. At step 410 a need of a user is captured by receiving a query from the user. The query may specify the need of the user for particular information. Further, the query may be received, from the user, in textual form such as a statement including text, a keyword, a phrase and the like. Furthermore, the query may be in form of a video and an audio. Further, the user's context (Rich context), including the user's information, may also be captured. The user's information may include the user's current location and situation. For example, the user's context, such as the user's birthday, travel plan and the like, may be captured from the user's profile. Such information corresponding to the user may be utilized further for processing, as explained in step 415.

In an embodiment, the user may specify the need by utilizing various electronic devices, as described in conjunction with FIG. 1. Also, the need received from the user may be of various types that may be classified into various categories. Various types of the need may include, but are not limited to, a personal need, a social need and an informational need. In an embodiment, the personal need may specify personal requirements of the user. For example, the personal need may include need of setting alarms or reminders corresponding to an event to remind the user. Further, the social need represents the need to interact with the user's social circle to obtain information therefrom. The social need, in one example, may include acquiring information concerning a particular friend within the user's social circle. Further, the social need may include need of receiving recommendations, corresponding to the user's query, from one or more social networks such as Face-book, Twitter, Orkut, LinkedIn, MySpace, Mybantu and the like. Furthermore, the informational need may be regarded as a need for domain specific information such as information regarding news, current affairs and the like. Further, the need of the user may be processed, as explained further.

At step 415, the need is processed to generate a set of actionable recommendations. The set of recommendations may include a limited number of recommendations such as ‘1’ to ‘9’. Processing of the need includes identifying domain corresponding to the need and intent of the user, present in the need. Further, the intent of the user may be identified by determining a type of the need. Based on the domain and intent of the user, the need may be processed by querying appropriate internal and external sources (hereinafter referred to as search sources). The sources may be queried to generate the result as a set of actionable recommendations. The set of actionable recommendations may include a limited number, such as one to nine, of relevant recommendations based on the need. Further, processing of the need may be based on the rich context (as mentioned in step 410).

The various sources (as described earlier) may include, but are not restricted to, web search engines, various web sites, databases and the like. The sources may be selected to gather information based on the type of the need. For example, if the need is an informational need i.e. if the need captured (as explained in the step 410) from the query corresponds to acquiring the information related to a particular domain then the information may be gathered from sources such as domain specific sites. Further, if the query corresponds to acquiring information corresponding to a friend then the need may be categorized as a ‘social need’. In this case, the information may be gathered from social web sites.

Processing may include various phases to process the need of the user. The various phases may include, but are not limited to, a need analysis phase, a searching phase, an aggregation phase, a ranking and filtering phase and a generating phase to generate a set of recommendations associated with the need. The need analysis phase includes analyzing the need. The query, expressing the need, is analyzed to understand the intent of the user. The query may include text describing various parts of speech, for example, verb, noun, pronoun, adjective, adverb, preposition, conjunction and interjection. The need analysis phase may include segregating the text describing the various parts of speech. Segregation is done for identifying the intention of the need. For example, if the query includes ‘movie booking in nearby AMC’, then in an embodiment, the need analysis phase may segregate nouns, such as ‘movie’ and ‘AMC’, and verb such as ‘booking’ from the query. In an embodiment, Natural Language Processing (NLP) algorithm may be utilized to perform segregation. NLP algorithm identifies natural human language and converts it into a format that may be interpreted for computer program manipulation purposes.

Further, processing may include identifying a category (type) of the need (as explained earlier) based on the analysis of the need. Furthermore, processing may include identifying a domain associated with the need. Examples of the domain include, but are not limited to, movie, music, entertainment, travel, television, computer, books, electronics, jewelry, automotive, restaurants trade, banking, business, education and sports. The domain associated with the need may be identified by utilizing a domain categorization technique. Further, the domain categorization technique may include various phases. Examples of various phases, of the domain categorization technique, may include, but are not limited to, an entity extraction phase and an entity recognition phase.

Various algorithms may be used to perform the entity extraction phase. The entity extraction phase may include extracting an entity associated with the need. The entity may include, but is not limited to, celebrities, place and action associated with the need. In one embodiment, a Right Most Matching string (hereinafter referred to as ‘RMMS’) algorithm may be used for extracting the entity in entity extraction phase. The RMMS algorithm may identify a domain ontology associated with the need. In one embodiment the domain ontology may include a database for storing one or more domains. Further, RMMS algorithm also identifies a generic ontology associated with the need. The RMMS matches the entity with a domain specific entity that may be stored in the domain ontology. In one example, a Dbpedia may be referred to as the generic ontology. Furthermore, a phrase describing the need may also be used to extract the entity associated with the need. Moreover a domain specific ontology may also be used to extract the entity associated with the need.

The entity recognition phase is employed to perform matching of the entity associated with need with a plurality of entities stored in a reference database system. Examples of the reference database system may include, but are not limited to, a Wordnet, and a Freebase. Entities extracted from the Dbpedia or the phrase describing the need is transmitted to the Wordnet. The Wordnet is employed to identify the entity and further extract the various parts of speech associated with the entity identified by the Wordnet. Entity may be identified by matching the entity extracted using the entity extraction phase with one of the entities stored in the Wordnet. In one example, a name of the entity can be matched with one of a plurality of names stored in the Wordnet. In another example, a location, from the entity corresponding to place, may be matched with one of a plurality of locations stored in the Wordnet.

Further, parsers like the Stanford parser may also be employed to identify the various parts of speech associated with the entity. Furthermore, on identifying, the various parts of speech may be transmitted to the freebase to identify the domain associated with the need. Output obtained from the entity extraction phase and the entity recognition phase may be stored for later references by the user.

Upon performing need analysis, search based on the domain is performed. Searching can be performed from various sources (through search providers) such as search engines, social networking sites, public networks, directories and special sites. Examples of search engines include, but are not limited to, Google.com, Yahoo.com, Ask.com, Shopzilla.com, and altavista.com. Domain specific sites may include yahoo.local, Amazon, BestBuy, Walmart, Kayak, Rotten Tomato, Sabre, Last.fm etc. Searching provides a large list of recommendations associated with the need.

Such large list of recommendations from various sources may be aggregated. Upon aggregation, filtering is performed on the large list of recommendations to determine more relevant recommendations, from the list of recommendations, corresponding to the need of the user. Filtering may be done based on the user's preferences that may be specified by the user. Further, filtering may be based on learning (machine learning of user behavior) from the user's previous needs as well as previous selection of various options to fulfill the need. Each of the service providers may either provides ranking or returns the results in order of relevance. Results from search providers for different domains may be selected in proportion of the domain weightage (or confidence) that may be computed. Accordingly top ranked results in proportionate with the domain weightage may be selected in the filtering phase. Upon filtering, a relevant list of actionable recommendations, corresponding to the need, may be generated.

Further, the recommendations included in the relevant list may be ranked to generate a ranked list of recommendations. Ranking may be performed based on various factors such as rankings, ratings and opinions, corresponding to the need, derived from various sources. For example, various external sources like Yelp, Yahoo.locals, Rotten Tomato, give rankings and reviews. The solution may normalize ranking from various sources to its own ranking. Further ranking may also be performed based on a browsing history of the user. Furthermore, ranking may also be performed based on the user preferences. In an embodiment, the user preferences may be determined through the query, corresponding to the need, received from the user. Ranking may be performed using various techniques. In one example, heuristic algorithms may be used to perform ranking. From the ranked list, higher ranked recommendations may be selected to generate a relevant set of recommendations for the user.

In one embodiment, ranking aids the user to select an appropriate recommendation among the recommendations present in the relevant list. The ranked list of recommendations may be provided to the user to enable the user to select at least one of the set of recommendations and to perform one or more actions corresponding to the selected recommendation.

Further, the recommendations may be provided along with corresponding actions to enable the user to act corresponding to the recommendations and thereby enable the user to fulfill the need. Further, the list of recommendations may be analyzed to identify various actions associated with each of the recommendations present in the list, as explained further in step 420.

At step 420 one or more actions associated with each of the recommendations present in the relevant list may be identified to enrich the recommendations. The one or more actions corresponding to each of the recommendations may be identified by analyzing each of the recommendations present in the relevant list. In an embodiment, the recommendations may be analyzed by mapping each of the recommendations present in the relevant list to corresponding actions. Further, analysis can also be performed by maintaining an ontology including a plurality of recommendations along with their respective actions. In one example, if the recommendation is associated with a product then the one or more actions associated with the product can include, but are not limited to, reviews, rating, buying and contacting a vendor. In another example, if the recommendation is associated with an event then the one or more actions associated with the event may include, but are not limited to, reviews rating and booking tickets for the event.

Further, the recommendations may be enriched by identifying value added information corresponding to the recommendations. The value added information may include, but is not limited to, schemes, offers, lottery, links and the like. For example, the value added information may include a link corresponding to a recommendation to provide additional information to the user. For example, in case of a query corresponding to ‘tours and travels’, the recommendations may be enriched with one or more links for providing information corresponding to holiday packages to various places. Similarly, the value added information may include schemes such as free coupons that may be provided to the user on the user's selection of a particular recommendation.

It may be appreciated by any person skilled in the art that the value added information is not limited to as mentioned here. The recommendations may be enriched by adding various features to provide flexibility to the user in fulfilling the need.

At step 425, in the enriched set of actionable recommendations may be provided to the user to enable the user to perform one or more actions corresponding to a selected recommendation. In an embodiment, the user may be provided with one or more features to perform the one or more actions corresponding to the selected recommendation. For example, the user may be provided with a set of recommendations corresponding to the need of the user to dine in a restaurant. Such recommendations may include, but are not restricted to, names of the restaurants. Further, the user may be provided with features like ‘call’, ‘menu’, ‘book a table’ and the like to perform one or more actions corresponding to the recommendation. Further, in this case, the feature ‘call’ may be utilized by the user to make a call to a restaurant corresponding to a particular name of the restaurant from the list of the restaurants. Similarly, feature ‘menu’ may enable the user to view the menu corresponding to the selected restaurant from the list of recommendations. Again, feature ‘book a table’ may enable the user to book a table for a number of persons to dine in the restaurant.

Further at step 430, it is determined whether the set of recommendations (or ranked list of recommendations) provided to the user fulfills the need of the user. The user may analyze the set of recommendations, provided to the user, to determine if the need is fulfilled. If the need of the user is fulfilled by performing an appropriate action corresponding to the appropriate recommendation, then the method 400 proceeds to 435 (shown by the “Yes” branch from 430) and the method 400 gets terminated at 435. Further, if the need of the user is not fulfilled through the set of recommendations or by performing an action, by the user, corresponding to any recommendation of the set of recommendations, the method 400 proceeds to 440 (shown by the “No” branch from 430).

At 430, if the need of the user is not filled by providing the set of recommendations (or list of ranked recommendations), then the method 400 crystallizes the need by enabling the user to tune the query provided by the user. Further, the need may be crystallized by providing one or more concepts (or keywords) relevant to the recommendation, to the user to enable the user to select at least one concept therefrom. The one or more concepts may correspond to the need of the user and may be provided to the user to improve the need. Further, the categories may enable the user to represent the intent of the need of the user. In one embodiment, the need may be crystallized to entirely alter the need of the user.

Furthermore, the crystallized need may be provided to step 415 to process the crystallized need in a manner as described in above paragraphs. It may be appreciated by any person skilled in the art that the need may be crystallized to understand the clear intent of the user. Further, it may be appreciated by any person skilled in the art, the need may be crystallized and processed, and provided to the user iteratively

The user selected concepts or the user provided hint and the current needs processed context is processed by step 415, for the next iteration of the processing of the need. The existing need's context in the form of its intent, its domain as well as processed entities are carried forward to the next iteration of processing. The user selected concepts may either added to the earlier need one by one or all together to process further and get more relevant recommendations. If the user has selected any concept that replaces the concept expressed in the recommendation, then the step 415 would replace the existing concept with the new concept. For example, the recommendation has provided an Italian restaurant but in the hint the user gives an Indian restaurant then the subsequent search would replace Italian restaurant with Indian restaurant. Thus, this iterative process of crystallizing and processing the need may provide appropriate result (recommendations) corresponding to the need of the user.

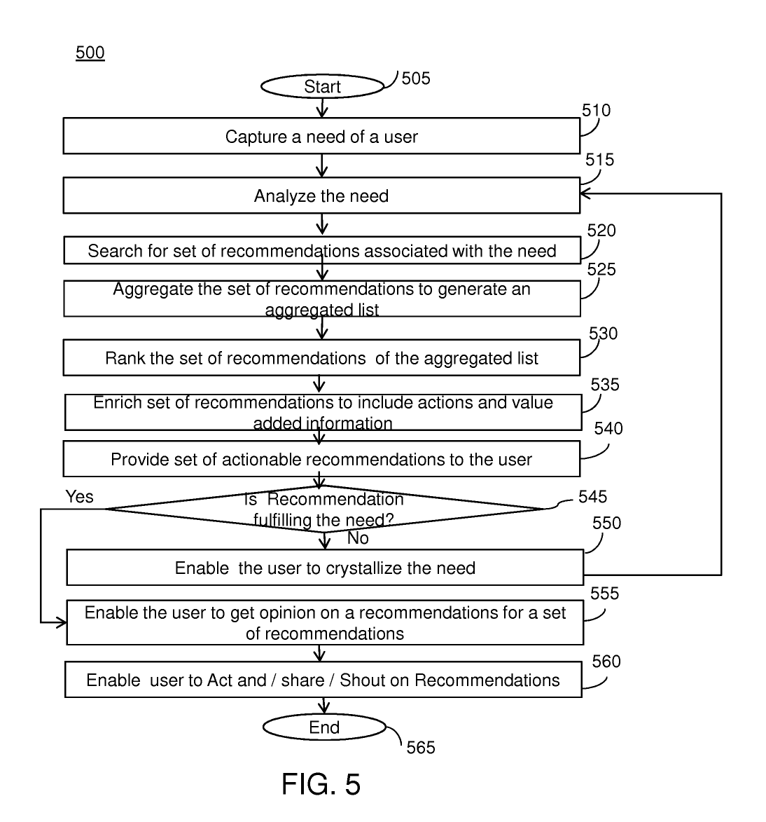

FIG. 5 is a flowchart illustrating a method for providing a set of recommendations to a user, in accordance with one embodiment of the present invention. Various steps of the method 500 are described earlier in conjunction with FIG. 2 and FIG. 4 and thus the corresponding explanation (of such method steps) is not repeated here for the sake of brevity. The order and number of steps in which the method 500 is described is not intended to be construed as a limitation.

The method 500 starts at step 505. At step 510, a need of a user is captured. Capturing can be performed by receiving a query corresponding to the need, from the user. The need may be captured based on a rich context that includes users profile information, situational context, location context.

At step 515, the need is analyzed to extract various keywords that may describe the need. Analysis may be performed by using various algorithms. Examples of various algorithms include, but are not limited to, Natural Language Processing (NLP), and ‘Rightmost Matching String’ (hereinafter referred to as ‘RMS’) Algorithm. Furthermore, various tools may also be used to analyze the need. In one example, Google's search API can be used to perform analysis of the need.

Further, the need may be analyzed to identify a type of the need. The need can be classified into various categories (types). Examples of various categories of the need include, but are not limited to, a personal need, a social need and an informational need. The personal need, in one example, may include, but is not limited to, setting a reminder for the user. The social need may correspond to receive information or recommendations from a social circle of the user. For example, the social need may include identifying a contact number of a first friend by acquiring the contact number from a second friend. The informational need may correspond to retrieving information specific to a particular domain. For example, the informational need may include searching data associated to a subject present in the World Wide Web. Classification of the need may be performed by identifying various features present in the need. Examples of various features include, but are not limited to, keywords, phrases, graphics and audio.

Furthermore, the need may be analyzed to identify an intention associated with the need. The intention of the user corresponding to the need may be extracted by identifying keywords from the query describing the need. In one example, NLP algorithm can be used to extract the intention of the user corresponding to the need. Further hints can also be used to identify the intent of the need. Hints can be regarded as words or phrases indicating the intent of the user. Furthermore, intent of the user can also be identified using various characteristics, for example, location, time and the like.

At step 520 searching to obtain set of recommendations associated with the need is performed. Upon identifying the intent, a set of recommendations associated with the need is searched. Searching may be performed based on, but not limited to, the intent of the user, rich context, user preferences, and user history. Searching may be performed from search engines such as Google, Yahoo and the like. Further, searching may be performed from specialized sites such as Amazon, kayak, rottentomotoe and the like. Furthermore searching may be performed from catalogs like Yelp, yahoo local, answers.com and the like. Moreover searching may be performed from domain specific sites such as movies.com, travels.com and the like.

At step 525, the recommendations obtained from various sources are aggregated to generate an aggregated list of recommendations. Aggregation includes consolidating the recommendations obtained from various sources generate the aggregated list of recommendations. Aggregation also includes selecting recommendations based on the intent, relevancy to the need, user preferences, rich context and the user history. The selected recommendations may be added to the aggregated list of recommendations.

At step 530, the aggregated list of recommendations is ranked. Recommendations from each of the various sources may be ranked independently. Further, the rankings from various sources are normalized to generate ranks to the aggregated list of recommendations. The aggregated list of recommendations is ranked based on various factors such as one or more user preferences, search history, rich context and the like. Various ranking algorithms can be used to perform ranking for example, boosting tree algorithm and the like.

The ranked results are further filtered based on the user's preferences. The user's preferences may be captured explicitly or may be learnt from the user's interactions. The selected ranked list of recommendations is provided to the user. In one embodiment, the ranked list of recommendations may be provided to the user directly to enable the user to select recommendations from

At step 535 the selected ranked list of recommendations are enriched. The set of recommendations may be enriched by determining set of actions associated with each of the set of recommendations. Various algorithms may be used to determine the set of actions associated with each of the set of recommendations. Further, the set of recommendations may be enriched with the value additions. The value additions may provide as a result of enrichment includes additional information corresponding to the set of recommendations. In one example, value additions may include coupons, offers, discounts and the like associated with the recommendations.

At step 540 the set of recommendations along with enriched information is provided to the user. The user may be enabled to select one of the recommendations based on choice of the user from the set of recommendations.

At step 545 the method 500 determines whether the set of recommendations are sufficient (or relevant) to satisfy the user or to fulfill the need of the user. If the user is satisfied then the method 500 proceeds to step 555 (shown by a “Yes” branch from 545). Further, if the user is not satisfied with the set of recommendations provided then the user may crystallize the need (shown by a “No” branch from 545).

At step 550, the user may be enabled to crystallize the need. In an embodiment, the user may wish to crystallize the need if the ranked list of recommendations does not fulfill the need of the user. Further, in another embodiment, the need may be crystallized by the user if the ranked list provided to the user, is significantly large or, includes irrelevant recommendations. In such cases, the user may crystallize the need to limit a number of recommendations in the ranked list. In an embodiment, processing of the crystallized need may narrow down the number of searched recommendations by searching the most relevant recommendations (based on the crystallized need) while processing.

In an embodiment, the need crystallization process can be referred to as a feedback provided by the user to refine the need. The user may be provided with hints to refine the need. Further, multiple options may be provided to the user to enable the user to refine the need. Options may be provided to the user to understand the intent of the user.

Upon providing the feedback by the user, set of recommendations relevant (hereinafter referred to as “relevant recommendations”) to the need may be obtained from the various sources. The set of relevant recommendations to the need include set of actionable recommendations. The set of actionable recommendations may enable the user to perform set of tasks in response to the need. In an embodiment, if the user is satisfied with the ranked recommendations provided to the user, the user may not crystallize the need to obtain more relevant recommendations.

At step 555, the user may be enabled to get opinion on each recommendation of the set of recommendations. The user may get opinion from, but not restricted to, other users such as friends, experts through the social networking sites. The user may look for opinion on any recommendation if the user is satisfied with the provided set of the recommendations. The concept of getting opinion has already been explained in this document and thus not repeated here for the sake of brevity. Further, the user may be enabled to select a recommendation from the set of recommendations provided. The user may select one of the actionable recommendations to perform actions corresponding thereto.

At step 560, the user is enabled to perform actions corresponding to the selected recommendation. It may be appreciated by any person skilled in the art that the user may be provided with one or more options to enable the user to perform actions corresponding to each of the selected recommendations. Such actions may enable the user to fulfill the need of the user. For example, the user may be provided with one or more options such as ‘call’, ‘buy’ to do call or purchasing respectively. Further, at step 560, the user may be enabled to provide feedback corresponding to the selected recommendation to the other users through social network. Furthermore, the user may be enabled to share the selected recommendations or to Shout-out to represent likes/dislikes for the selected recommendation, to the other users of local community or a public social networking community or with specified one or more users. Further, the method ends at step 565.

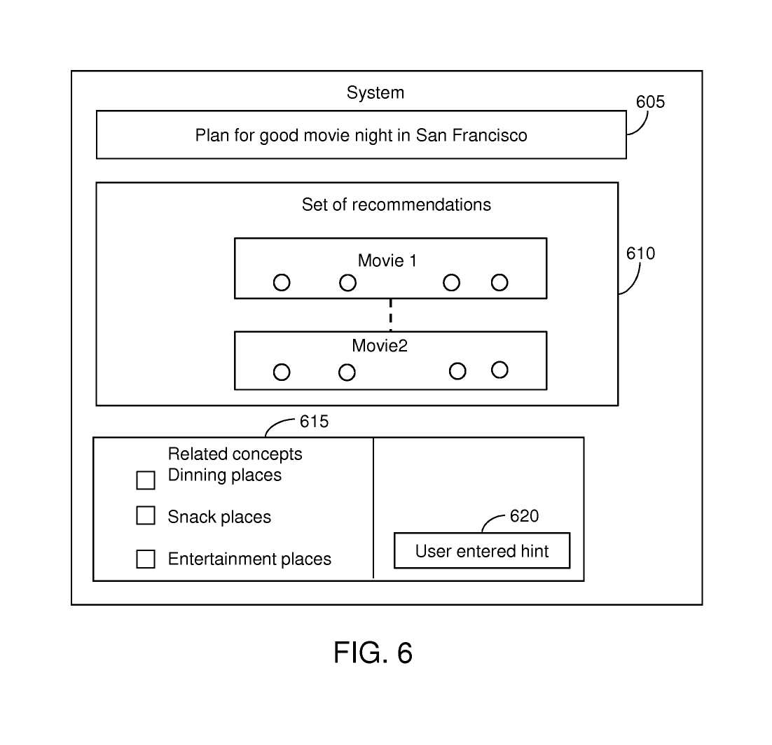

FIG. 6 represents an exemplary illustration for need fulfillment in accordance with one embodiment of the present invention. A need can be expressed by a user by providing a query. The need can be expressed in various forms such as a sentence, a phrase, a keyword, an image, an audio, graphics and the like. In the present example, the need includes a sentence “Plan for good movie night in San Francisco” as shown in 605. The system 120 (hereinafter referred to as the ‘system’) analyses the need. Further, the system performs searching to obtain set of recommendations corresponding to the need of the user. The system may utilize various sources to search the movie recommendations for fulfilling the need of the user. In the current example, the system may communicate with a location extractor to acquire information associated with location, such as ‘San Francisco’, as mentioned in the need 605. The location extractor may be regarded as a database that includes multiple locations. However, in some devices, for example smart mobile phones, the location of the user can be obtained from the device in the form of longitude and latitude.

Further, the system may communicate with a date-time extractor to acquire information associated with the date and time mentioned in the need. The need 605 indicates the time of the day. The date and time extractor captures the word “evening” present in the need 605.

Further, the system identifies movie as a domain associated with the need. A domain categorization technique may be used to identify the domain associated with the need. Examples of the domain include, but are not limited to, movie, music, entertainment, travel, television, computer, books, electronics, jewelry, automotive, restaurants trade, banking, business, education and sports. The domains may be stored in a domain database. The need 605 can be associated with one or more domains, for example, restaurants, entertainment, tourists and the like.

The system may perform search corresponding to the one or more domains associated with the need 605. In this case, when the Need is identified as in movie domain, then movie specific Search may be performed to obtain set of recommendations as shown in 610 associated with the need 605. When a need belongs to multiple domains, for example, need like, “good romantic evening in San Francisco”, then Search can be performed from various sources. Examples of various sources include, but are not limited to, Google, Yahoo, Dbpedia, social networking sites, specialized sites such as ‘Yelp’ and the like. Various sources may be queried to get search result for the need and the results are aggregated. Further, the list of set of recommendations may be ranked. Ranking can done based on user preferences, as well as domain specific ranking method. For example, if the user likes Action or Romantic Comedy then only Action or Romantic Comedy movies from the currently running movies are given higher rank and selected. Furthermore, ranking can also be performed independently upon obtaining each of the one or more recommendations from various sources. The set of recommendations that are ranked obtained from various sources are consolidated to provide a single list including set of recommendations relevant to the need. The single list including one or more recommendations relevant to the need is associated with set of actionable tasks that can be accomplished to fulfill the need 605 of the user.

The single list including set of recommendations associated with the need 605 may be provided to the user. The user can select one of the recommendations including relevant action to fulfill the need 605. Further, if the user is not satisfied with the set of recommendations, the system may provide hints to the user. Hints allow the user to define the need in a prominent manner. Further, related concepts associated with the set of recommendations may be presented to the user as shown in step 615. Hints, such as ‘dining places’, ‘snacks places’, ‘entertainment places’ and the like, may be associated with the need 605. The need “a plan for a good movie night in San Francisco” 605 may have additional activities around the recommendation for the movies. These are Need level hints. User feedback (or hints) on specific recommendation of movie may include concepts like movie genre, movie rating, movie actors or directors, movie plot, etc. Those concepts can be used for iteratively refining the need. Furthermore, the user can select hints and enter hints to get one or more recommendations relevant to the need. The user can enter the hints in the hint-window as shown in 620.

Upon entering the hints, the system may perform search to obtain one or more recommendations associated with the hint provided by the user. Hints can indicate the domain associated with the need, thereby enabling the system to understand the intent of the user prominently. Upon searching, the one or more recommendations (not shown) associated with the hints are provided to the user. The user can select one of the recommendations including relevant actions for fulfilling the need. In one example, if the user provides “Dining places” as a hint, then the system searches for various restaurants located in ‘San Francisco’. Further, the system may communicate with the location extractor to obtain the address of the various restaurants located in ‘San Francisco’. Upon searching based on the hint “Dining places”, the need fulfillment system provides a list of recommendations including, for example, restaurants located in San Francisco. One of the recommendations can be selected based on the preference of the user. In one embodiment, the user's selection for the recommendation may be stored in a database for learning of the system that may be utilized in future searches corresponding to the need of the user.

Upon selecting one of the recommendations such as selecting one of a restaurant located in San Francisco, the system may provide rich information associated with the selected restaurant to the user. Examples of rich information include, but are not limited to, providing a menu card of the selected restaurant, providing a coupons, providing information regarding the style of food offered in the selected restaurant, booking a table, review and the like. The rich information provides the user with necessary information associated with the selected recommendation. Further, the rich information allows the user to take a decision corresponding to the recommendation. Furthermore, in one embodiment, the user may be provided with actionable recommendations that enable the user to act on the decision of selecting a particular recommendation, from the list of recommendations, to fulfill the need of the user. Examples of actionable recommendations can include, booking a table, selecting menu for dinner and the like. Similarly rich information associated with various domains is provided to the user depending upon the need of the user.

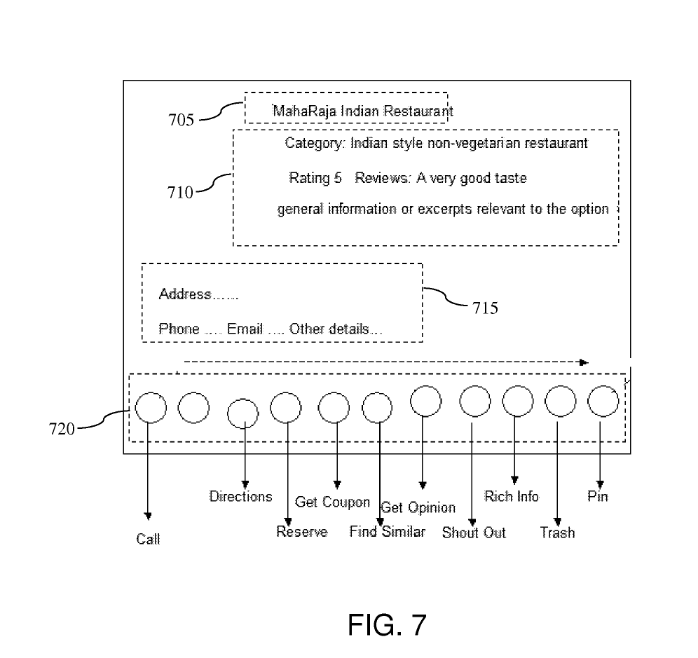

FIG. 7 is an exemplary illustration for set of recommendations and corresponding actions associated with the need. The query “Maharaja Indian Restaurant” as shown in 705 is provided by the user. The need 705 may be processed to obtain set of recommendations associated with the need 705. The need 705 is captured. Capturing is performed by receiving a query provided by the user. Further, the need 705 may be captured by obtaining information present in a rich context of the user. Upon capturing the need 705, the need is pre-processed. Pre-processing is performed to identify the type of the need.

Upon pre-processing the need may be analyzed to determine an intent corresponding to need. The need may be analyzed based on heuristics. Further, the need may be analyzed by parsing the need. Parsing may be performed by utilizing various algorithms. In one example the NLP algorithm can be utilized to perform parsing. The NLP algorithm may identify natural human language and convert it into a format that can be interpreted for computer program manipulation purposes. Further, the need may be analyzed to determine a domain associated with the need. A RMMS algorithm may be used to determine the domain. The RMMS algorithm may determine the domain by identifying an entity associated with the need. The domain for the need 705 may be identified as “restaurant” based on the keyword “restaurant” included in the need 705.

Upon identifying the intent associated with the need searching for the set of recommendations as shown in 710 is performed. The set of recommendations may be searched from various sources. Examples of various sources include, but not limited to, search engines such as Google, Yahoo and the like, domain specific databases such as, movie database, music database, news search and the like, social networking sites such as Orkut, Facebook, Twitter and the like, public sites, specialized sites such as yelp, answers.com, Trueknowledge.com and the like, business directories, product categories and the like.

The recommendations obtained may include actionable recommendations that enable to perform actions such as call, email and the like, personalized recommendations, recommendations based on a rich context, recommendations based on user preferences and the like. Further, recommendations may be provided based on hints as shown in 720 entered by the user. Hints may include an option “find similar” may be used to determine recommendations similar to the recommendations. Further, hints may include rating for the restaurant “Maharaja”. Furthermore, hints may include reviews for the restaurant “Maharaja”. The ratings and reviews may be provided by friends or experts through social networking sites or public sites and the like.

Further, the set of recommendations may include value added information, such as coupons and various offers, corresponding thereto. The actionable recommendations may include one or more actions such as calling the restaurant “Maharaja” to book a table, sending an email to determine menu provided by the restaurant “Maharaja” and other details as shown in 715.

Further, if the user is not satisfied with the set of recommendations provided, the user can provide a feedback as shown in 720. The feedback may define a need accurately. Further, feedback may be provided in the form of indicating an option “find similar”. The option “find similar” may be used to determine recommendations similar to the recommendations included in the ranked list. Furthermore, feedback may be in the form of selecting an option, in one example, “like”. The options “like” may indicate if the user is interested in a particular recommendation. In another example, the user can select an option “trash” indicating that the user is not interested in a particular recommendation. Moreover, feedback may be in the form of selecting a “pin-in” option. The “pin-in” option may be utilized by the user to save the recommendation for future use.

Further, 720 may include value added information such as “coupons” available for providing discounts, direction map to reach “Maharaja” restaurant and the like. The value added information may provide essential details associated with the restaurant “Maharaja”.

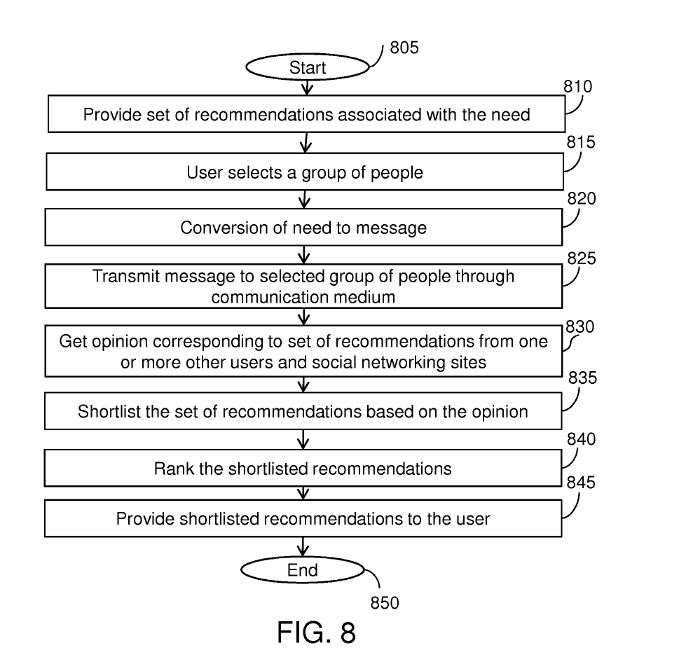

FIG. 8 is a flowchart illustrating a method for getting opinion for set of recommendations, in accordance with one embodiment of the present invention. The method starts at step 805. At step 810, set of recommendations associated with the need are provided to the user. The set of recommendations are provided to the user by processing the need. Processing the need includes searching for the set of recommendations responsive to the need from various sources. The set of recommendations may include set of actionable tasks that can be accomplished to fulfill the need of the user.

At step 815, the user can select a group of people for providing opinions on the set of recommendations. The group of people can include friends, experts, colleagues and the like. Various communication mediums can be used for obtaining opinions on the set of recommendations. Examples of various communication mediums include, but are not limited to, social networking sites, public sites and the like.

At step 820 the need is converted to a message. The message may be prefilled by the system or formulated by the user. The message may describe the need in a standard form. The message can be formulated using templates. Further, the templates can be provided by the system for converting the need into a standard form. Formulation of the message allows the group of people providing opinions to understand the intent of the need. Furthermore, opinions can also be provided by people independent of the selected group. The system may provide an option to the user for enabling the user to acquire opinions from the selected group or by people independent of the selected group.

At step 825, the message describing the need of the user is transmitted to the selected group of people. Further, the user can also transmit the message describing the need to people independent of the selected group. The message can be transmitted through the various communication mediums such as social networking sites, public sites and the like.

At step 830, opinions are acquired for the set of recommendations associated with the need. The set of selected (by user) recommendations associated with the need are disseminated to the selected group of people. Further, the set of selected (by user) recommendations associated with the need can be disseminated to people independent of the selected group. Upon disseminating the one or more recommendations, opinions can be obtained also from public sources such as social networking sites or special review sites specific to the type of recommendation to get the talk of the town or buzz in the social world about the recommendation. Such opinion may be called as Public opinion. Meanwhile, one or more receivers of the get Opinion request may respond with their opinions. Opinions from the various sources can be obtained through various communication mediums.

At step 835, the one or more opinions associated with the recommendation are shortlisted. Shortlisting can be performed based on user preferences. In one example if large numbers of people provide a particular opinion for a particular recommendation relevant to the need then the particular recommendation can be shortlisted. Further shortlisting can also be performed based on the opinions provided by various sources.

At step 840 the shortlisted opinions are ranked. Ranking can be performed based on user preferences. Further, ranking can also be performed based on opinions provided by various sources. Furthermore, ranking can also be performed based on reviews associated with the shortlisted recommendations. Ranking can be performed using ranking algorithms. The opinions provided by other users may be employed in decision making, to select a recommendation from the shortlisted recommendations, by the user.

At step 845 the shortlisted recommendations based on opinions are provided to the user. The user can select one of the shortlisted recommendations that enable the user to perform task to fulfill the need. The selection of one of the shortlisted recommendations is performed using user interfaces. The user can perform the task to fulfill the need. The method ends at step 850.

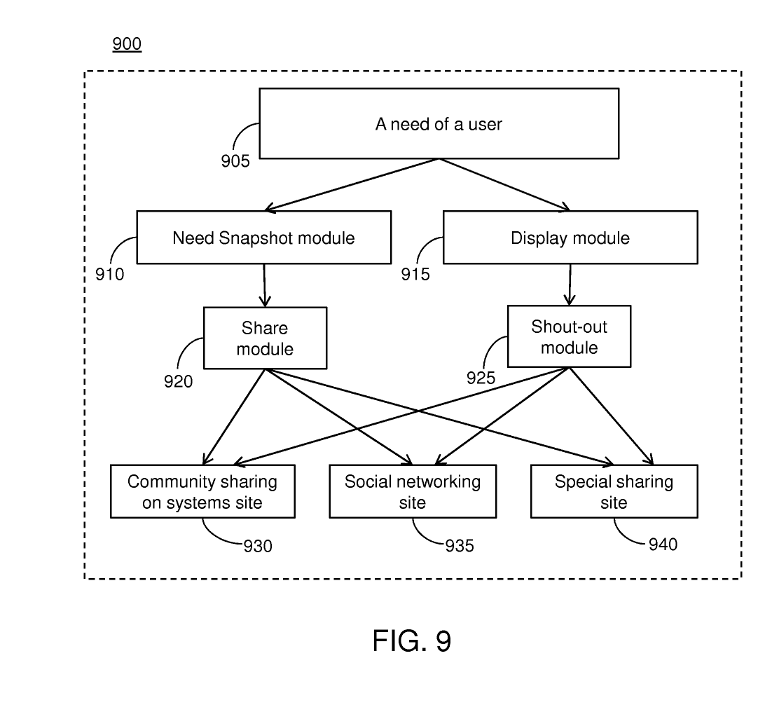

FIG. 9 is a block diagram to illustrate Share and Shout-Out actions in accordance with one embodiment of the present invention. The block diagram 900 includes a need of a user 905, a need snapshot module 910, a display module 915, a share module 920 and a Shout-out module 925

The Share and Shout-Out actions can be employed to express a notion of the user on set of recommendations provided by a system, such as the system 120. Set of recommendations including actionable task responsive to the need of the user 905 are provided to the user.

The need snapshot module 910 captures a snapshot of the need. Further, the need snapshot module also captures the set of recommendations responsive to the need. The display module 915 displays the set of recommendations including actionable task responsive to the need.

The user can select set of recommendations including an actionable task responsive to the need. The share module 920 may enable the user to share the need along with corresponding recommendations. Sharing allows shortening down search time for multiple users with the same need. The user can share the need along with corresponding recommendations on various sites, for example, community sharing site 930, social networking site 935 and special sharing site 740. The community sharing sites 930 may be specific to a particular system.

The shout-out module 925 is used to express the notion of the user on selected recommendation. In one example, if a user is happy with a particular recommendation including a relevant action responsive to a particular need, then the user can share his happiness. Words and phrases can be used to describe the notion of the user on the particular recommendation. In another example, if the user is not satisfied with a particular recommendation or if the intent of the user is not understood, then the user can share his feelings by telling, for example, “not great”. The users can shout-out on various sites, for example, community sharing site 930, social networking site 935 and special sharing site 940.

The user can share the notion on one or more recommendations using various communication mediums. Sharing allows multiple users to derive conclusions for their need. The user can share the need along with corresponding recommendations through various sites, for example, a community sharing site as shown in 930, a social networking site as shown in 935, a special sharing site as shown in 940 and the like.

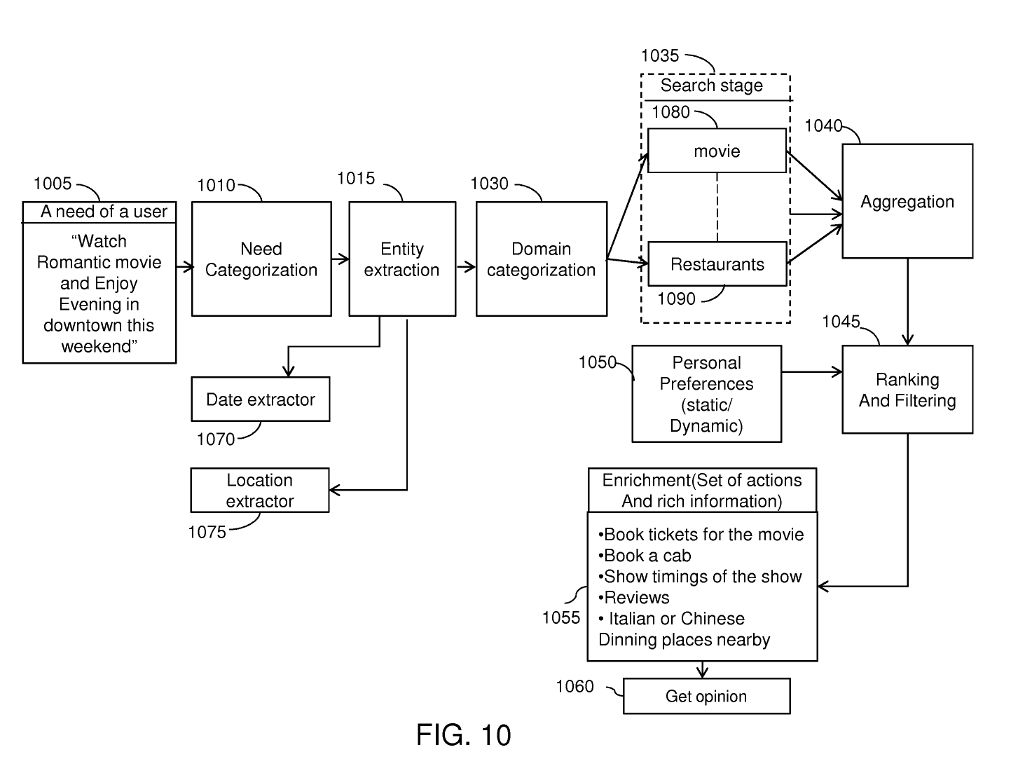

FIG. 10 is an exemplary illustration of a need associated with relevant actions for fulfilling the need, in accordance with one embodiment of the present invention. The description of the FIG. 10 may be understood in conjunction with description of FIG. 2, FIG. 3, and FIG. 4.

A user expresses the need in the form of a sentence “Watch Romantic movie and Enjoy Evening in downtown this weekend” as shown in the block 1005. A system, such as the system 120, captures the need 1005. Further, the system performs need categorization as shown in block 1010. The need categorization is performed to identify the category associated with the need. The system identifies the need 1005 as an informational need. Upon need categorization, a need processing system captures nouns “movie”, “downtown” and “weekend” included in the need 1005. Further, the system also captures the verbs “watch” and “Enjoy” included in the need 1005.

The system identifies the verb “watch” included in the need 1005. Further, the system communicates with an entity extractor to extract entities from the need 1015. The entity extractor 1015 includes a date extractor 1065 and a location extractor 1070. The system communicates with the date extractor 1065 to identify the date associated with the noun “weekend” included in the need 805. Further, the location extractor 1070 may identify the location “downtown” included in the need 1005.

Upon identifying the location and the date, the system performs a domain categorization technique as shown in block 1030. The domain categorization technique may be performed that recognizes “watch” as an intent and “movie” as another entity hinting “movie” domain and hence identifies the domains as Entertainment, and Movies associated with the need 1005. Restaurant can be associated with the enjoyment in the Entertainment domain for the food loving user. Various domains can be stored in a domain database. Further, separate databases can be maintained for each of the domains stored in one example a search stage 1035. In one example, a movie domain 1080 can be associated with a movie database. Multiple movies can be stored in the movie database. Another domain, a restaurant domain 1090 may be associated with a restaurant database. Further, many other domains may be associated with the need.

Based on the verb “watch” included in the need 1005, the system estimates that the intention of the user corresponding to the need 1005 refers to watching a movie. Hence the need fulfillment system communicates, in the search stage 1035, with the movie database and captures movies with genre as “romantic”. If a specific movie name was specified by the user in the need, for example, the words “jack goes boating” may included in the need 1005. In that case, the system compares the words “jack goes boating” included in the need 1005 and multiple movies included in the movie database. If a match between them is found, then the system concludes that the intention of the user corresponding to the need 1005 refers to watching movie named “jack goes boating”.

Further, the aggregation module 1040 aggregates the search results from various sources (as explained earlier in this document).

Further, the ranking and selection module 1045, ranks the received recommendations I the movie and restaurant domain based various algorithms including rankings specified on the sources rankings, rankings based on the users preferences received from the user preference or personalization module 1055. The user preferences may have been specified by the user or may be derived from the users previous interactions. The user preferences in this example can identify the user's preference such as actors or actresses, or type of restaurant so that personalized recommendations can be provided to the user.

Further, the personal preferences 1050 (personalized information) may be utilized for identifying the type of movie, rating, actors etc. implied in the intent of the need 1005 by the user. Furthermore, the information corresponding to entity extraction 1015 may be utilized for identifying the domain associated with the need. The personalized information may include user profile information.

Further, the system provides enriched information corresponding to the set of actionable recommendations as shown in block 1055 responsive to the need 1005. The actionable recommendations can be obtained by searching from various sources. Further opinions may be obtained from friends and experts as explained in conjunction with FIG. 8. The enriched information 1055 includes a set of actions and rich information corresponding to the user. For example, the enriched information may include, but is not limited to, providing web links for, identifying theatres located close to “downtown”, booking tickets for the movies for example “Jack goes to boating”, booking a cab to reach a particular theatre playing the movie “jack goes boating”, and reviews associated with the movie “jack goes boating”. Reviews may be obtained from various sources, for example, friends, experts, colleagues, specialized movie sites, social networking sites and the like. Reviews allow the user to make a decision while fulfilling the need.

Advantageously, the disclosed invention provides a personal assistance to fulfill a need of a user by providing actionable recommendations to the user. This enables the user to perform one or more actions by selecting a recommendation from the provided actionable recommendations. Further, the invention provides filtering of the recommendations to obtain relevant recommendations associated with the need. Furthermore, the invention reduces a significant amount of time required to perform search by providing relevant recommendations, obtained from various sources to fulfill the need, of the user. Also, the disclosed invention allows the user to provide feedback to crystallize the need based on user's desires. Further the disclosed invention allows the user to get opinions from other users such as friends and experts. Opinions may be utilized in the process of decision making by the user.

Moreover, the present invention enables the user to receive recommendations from any social circle (such as friends, experts and the like) by utilizing various social networking web sites. Additionally, the disclosed invention provides value additions such as various schemes and offers corresponding to the recommendations that enable the user to directly take the benefit of such value additions by selecting the corresponding recommendation. It may be appreciated by any person skilled in the art that the present invention may not be limited to the advantages as mentioned here above. Further, the present invention may provide various other advantages to the user of the system.

The present invention may also be embodied in a computer program product for providing one or more solutions to fulfill a need of a user. The computer program product may include a non-transitory computer usable medium having a set program instructions comprising a program code for providing one or more actionable recommendations. The set of instructions may include various commands that instruct the processing machine to perform specific tasks such as providing the one or more actionable recommendations and enabling the user to perform one or more actions corresponding to the one or more actionable recommendations to fulfill the need of the user. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A method for providing one or more solutions to fulfill a need of a user, the method comprising:
capturing the need of the user, the need captured by receiving a query from the user;
processing the need to generate a set of actionable recommendations, the need being processed by determining a type of the need;
enriching the set of actionable recommendations by identifying one or more actions corresponding to the set of actionable recommendations, the one or more actions being identified by analyzing the set of actionable recommendations; and
providing the enriched set of actionable recommendations and one or more features corresponding to the one or more actions to the user, the one or more features enabling the user to perform at least one of the one or more actions corresponding to the enriched set of actionable recommendations.

2. The method of claim 1, wherein the need is captured through at least one of users preferences and history of performing one or more actions for fulfilling the need of the user.

3. The method of claim 1, wherein the set of actionable recommendations is generated based on context corresponding to the user.

4. The method of claim 1, wherein the type of need comprises at least one of an information need, a social need and a personal need.

5. The method of claim 1 further comprising providing ranks to each of the one or more recommendations.

6. The method of claim 1 further comprising enabling the user to receive opinion from users of one or more social networks, the opinion corresponding to the need of the user.

7. The method of claim 1 further comprising:
assisting the user in crystallizing the need, the user being assisted by providing one or more optional hints to improve the query;
processing the crystallized need to generate a set of improved actionable recommendations;
providing the set of improved actionable recommendations to the user; and
enabling the user to perform at least one action corresponding to at least one of the set of improved actionable recommendations.

8. The method of claim 1, wherein the set of recommendations being further enriched by identifying one or more available schemes corresponding to the one or more recommendations.

9. The method of claim 1 further comprising enabling the user to provide feedback corresponding to the enriched set of actionable recommendations.

10. A method for providing solutions for fulfilling a need of a user, the method comprising:
receiving a query from a user, the query received for capturing the need of the user;
processing the need to generate a set of actionable recommendations, the need being processed by determining a type of the need;
providing the set of actionable recommendations to the user;
enabling the user to get opinion corresponding to the set of recommendations, the user being enabled to get opinion from one or more other users; and
enabling the user to perform one or more actions corresponding to at least one of the set of actionable recommendations, thereby providing the solutions for fulfilling need of the user.

11. The method of claim 10, wherein the user being enabled to perform the one or more actions by:
identifying the one or more actions based on the set of actionable recommendations; and
providing one or more features corresponding to the one or more actions to enable the user to perform the one or more actions.

12. A system for providing one or more solutions to fulfill a need of a user, the system comprising:
a need capturing module configured to capture the need of the user, the need captured by receiving a query from the user;
a processing module configured to process the need to generate a set of actionable recommendations, the need being processed by determining a type of the need;
an enriching module configured to enrich the set of actionable recommendations by identifying one or more actions corresponding to the set of actionable recommendations, the one or more actions being identified by analyzing the set of actionable recommendations; and
an output module for providing the enriched set of actionable recommendations and one or more features corresponding to the one or more actions to the user, the one or more features enabling the user to perform at least one of the one or more actions corresponding to the set of actionable recommendations.

13. The system of claim 12, wherein the need capturing module captures the need based on at least one of users preferences and history of performing one or more actions for fulfilling the need of the user.

14. The system of claim 12, wherein the processing module processes the need based on context corresponding to the user.

15. The system of claim 12, wherein the type of need comprises at least one of an information need, a social need and a personal need.

16. The system of claim 12, wherein the processing module is further configured to provide ranking to each of the one or more recommendations.

17. The system of claim 12, wherein the processing module enabling the user to receive opinion from users of one or more social networks, the opinion corresponding to the need of the user.

18. The system of claim 12 further comprising a need crystallization module configured for assisting the user in crystallizing the need, the user being assisted by providing one or more optional hints to improve the query.

19. The system of claim 12, wherein the enrichment module further enriching the set of actionable recommendations by identifying one or more available schemes corresponding to the set of recommendations.

20. The system of claim 12 further comprising a Share and Shout-out module for enabling the user to provide feedback corresponding to the enriched set of actionable recommendations.

21. A computer program product for use with a computer, the computer program product comprising a non-transitory computer usable medium having a computer readable program code embodied therein for providing one or more solutions to fulfill a need of a user, the computer readable program code when executed performing a method comprising:
capturing the need of the user, the need captured by receiving a query from the user;
processing the need to generate a set of actionable recommendations, the need being processed by determining a type of the need;
enriching the set of actionable recommendations by identifying one or more actions corresponding to the set of actionable recommendations, the one or more actions being identified by analyzing the set of actionable recommendations; and
providing the enriched set of actionable recommendations and one or more features corresponding to the one or more actions to the user, the one or more features enabling the user to perform at least one of the one or more actions corresponding to the enriched set of actionable recommendations.

22. The computer program product of claim 21, wherein the computer program code captures the need through at least one of users preferences and history of performing one or more actions for fulfilling the need of the user.

23. The computer program product of claim 21, wherein the set of actionable recommendations is generated based on context corresponding to the user.

24. The computer program product of claim 21, wherein the type of need comprises at least one of an information need, a social need and a personal need.

25. The computer program product of claim 21, wherein the computer program code further performs providing ranks to each of the one or more recommendations.

26. The computer program product of claim 21, wherein the computer program code further performs enabling the user to receive opinion from users of one or more social networks, the opinion corresponding to the need of the user.

27. The computer program product of claim 21, wherein the computer program code further performs:
assisting the user in crystallizing the need, the user being assisted by providing one or more optional hints to improve the query;
processing the crystallized need to generate a set of improved actionable recommendations;
providing the set of improved actionable recommendations to the user; and
enabling the user to perform at least one action corresponding to at least one of the set of improved actionable recommendations.

28. The computer program product of claim 21, wherein the computer program code further enriches the set of recommendations by identifying one or more available schemes corresponding to the one or more recommendations.

29. The computer program product of claim 21, wherein the computer program code further performs enabling the user to provide feedback corresponding to the enriched set of actionable recommendations.
